(19) United States
(12) Patent Application Publication
(10) Pub. No.: US 2015/0058972 A1
(43) Pub. Date: Feb. 26, 2015

(54) Method And Apparatus For Accessing An Application Program

(71) Applicant: TENCENT TECHNOLOGY (SHENZHEN) COMPANY LIMITED, Shenzhen City (CN)

(72) Inventors: Qing WANG, Shenzhen City (CN); Zhanghu LUO, Shenzhen City (CN); Zefeng HUANG, Shenzhen City (CN); Haoran GUO, Shenzhen City (CN); Quanhao XIAO, Shenzhen City (CN); Yixia YUAN, Shenzhen City (CN); Jiashun SONG, Shenzhen City (CN); Pengtao LI, Shenzhen City (CN); Yunfeng DAI, Shenzhen City (CN); Xunchang ZHAN, Shenzhen City (CN); Chunyou LIN, Shenzhen City (CN)

(21) Appl. No.: 14/520,384

(22) Filed: Oct. 22, 2014

Related U.S. Application Data
(63) Continuation of application No. PCT/CN2013/074741, filed on Apr. 25, 2013.

(30) Foreign Application Priority Data
Apr. 26, 2012 (CN) 201210126600.3

(51) Int. Cl. G06F 21/50; G06F 21/31

(52) U.S. Cl. CPC G06F 21/50; G06F 21/31
USPC 726/17

(57) ABSTRACT

An application program installed in a user device is monitored. if it is determined that a user requests access to the application program, it is determined whether the application program is encrypted. If the application program to which the user requests access is encrypted, the user is requested to input verification information and it is determined whether the verification information is correct. If the verification information is correct, the application program to which the user requests access is run and a running result is presented. If the verification is not correct, a protection operation is performed to the application program to which the user requests access.

### CROSS-REFERENCE TO RELATED APPLICATIONS

This application is a continuation of International Application No. PCT/CN2013/074741, filed on Apr. 25, 2013. This application claims the benefit and priority of Chinese Patent Application No. 201210126600.3, Apr. 26, 2012. The entire disclosures of each of the above applications are incorporated herein by reference.

### FIELD

The present disclosure relates to information security techniques and to a method and an apparatus for accessing an application program.

### BACKGROUND

This section provides background information related to the present disclosure which is not necessarily prior art.

User devices such as a cell phone, palmtop computer, or personal digital assistant (PDA) have become a tool for exchanging information and recording events. The user devices store a large amount of personal information and play an increasingly important role in people's daily lives.

Generally, the personal information recorded and stored in the user device is presented by an application program installed in the user device in advance. For example, network browsing history of the user is presented by a browser client installed in the user device. Book reading record of the user is presented by a reader client-installed in the user device. Information, such as game level or equipment of the user, is presented by a game program client-installed in the user device, and so on.

In an existing technique, an application program (e.g., browser, reader, or game program) which does not provide a password authentication procedure can be opened randomly. Thus, user information in this kind of application program can be obtained maliciously.

### SUMMARY

This section provides a general summary of the disclosure, and is not a comprehensive disclosure of its full scope or all of its features.

In view of the above problem, embodiments of the present disclosure provide a method and an apparatus for accessing an application program. The technical solution is as follows.

According to various embodiments of the present disclosure, a method for accessing an application program is provided. The method includes the following:

monitoring an application program installed in a user device; if it is monitored that a user requests to access the application program, determining whether the application program is encrypted;

if the application program that the user requests to access is encrypted, requesting the user to input verification information, determining whether the verification information is correct;

if the verification information is correct, running the application program that the user requests to access and presenting a running result; and

if the verification is not correct, executing a protection operation to the application program that the user requests to access.

The method further includes the following:

before monitoring the application program installed in the user device,

determining a relationship between the application program and an encryption level, wherein the encryption level is used for indicating whether the application program is encrypted, and whether the encryption level is unencrypted, encrypted, hidden, or hidden and encrypted; and

if the encryption level of the application program is hidden or is encrypted and hidden, hiding a user interface (UI) of the application program.

The method further includes the following:

after hiding the UI of the application program,

receiving an application program hidden cancellation request transmitted by the user, requesting the user to input a password, and verifying the password;

if the password is correct, displaying the hidden UI of the application program again.

Determining whether the application program that the user requests to access is encrypted includes the following:

querying a relationship between the application program that the user requests to access and the encryption level to obtain the encryption level of the application program that the user requests to access and determining whether the application program is encrypted according to the encryption level of the application program.

Executing the protection operation to the application program if the verification is not correct includes the following:

prompting the user to input the verification information again and returning to the process of determining whether the verification information is correct;

if the user has input error verification information for a predefined number of times, forbidding the running of the application program, or, outputting rapid information informing the user that the application program cannot be accessed.

Outputting the rapid information includes the following: informing the user that the application program has a fault via voice or a window.

According to various embodiments of the present disclosure, an apparatus for accessing an application program is provided. The apparatus includes the following:

one or more processors;

a memory; and

one or more program modules stored in the memory and to be executed by the one or more processors. The one or more program modules include: a monitoring module, a first determining module, a verification module, a first executing module, and a second executing module; wherein

the monitoring module is adapted to monitor an application program installed in a user device;

the first determining module is adapted to determine, when it is monitored that a user requests to access the application program, whether the application program that the user requests to access is encrypted;

the verification module is adapted to request, if the application program that the user requests to access is encrypted, the user to input verification information and determine whether the verification information is correct;

the first executing module is adapted to run, if the verification information is correct, the application program that the user requests to access and present a running result; and

the second executing module is adapted to execute a protection operation to the application program that the user requests to access if the verification information is not correct.

The apparatus further includes the following:

a second determining module, adapted to determine a relationship between the application program and an encryption level, wherein the encryption level indicates whether the application program is encrypted, and whether the encryption level is unencrypted, encrypted, hidden, or encrypted and hidden; and

a third executing module, adapted to hide a user interface (UI) of the application program if the encryption level of the application program is hidden or is encrypted and hidden.

The apparatus further includes the following:

a fourth executing module, adapted to receive an application program hidden cancellation request transmitted by the user, request the user to input a password, verify the password, and display the hidden application program again if the password is correct.

The second determining module is adapted to query a relationship between the application program that the user requests to access and the encryption level to obtain the encryption level of the application program, and determine whether the application program is encrypted according to the encryption level of the application program.

The second executing module includes the following:

a first executing unit, adapted to prompt the user to input the verification information again and trigger the verification module to determine whether the verification information is correct; and

a second executing unit, adapted to forbid the running of the application program if the user has input incorrect verification information for a predefined number of times, or output rapid information informing the user that the application program cannot be accessed.

The second executing unit is adapted to inform the user that the application program has a fault via voice or a window.

According to various embodiments of the present disclosure, a non-transitory computer-readable storage medium comprising a set of instructions for accessing an application program is provided. The set of instructions is provided to direct at least one processor to perform the following acts of:

monitoring an application program installed in a user device;

if it is monitored that a user requests to access the application program, determining whether the application program is encrypted;

if the application program that the user requests to access is encrypted, requesting the user to input verification information, and determining whether the verification information is correct;

if the verification information is correct, running the application program that the user requests to access and presenting a running result; and

if the verification is not correct, executing a protection operation to the application program that the user requests to access.

The technical solution provided by the present disclosure brings out the following advantages. When the user requests to access an application program, verification information input by the user is verified. If the verification information is correct, the application program that the user requests to access is run and a running result is presented. If the verification information is not correct, a protection operation is performed to the application program that the user requests to access. The technical solution effectively prevents malicious accessing of other users to the application program and ensures the security of the user information in the application program effectively.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Figures used in the descriptions of the following examples are briefly introduced herein to make the technical solution of the present disclosure clearer. It should be noted that the following figures are merely some examples. Those skilled in the art will understand many variations according to these figures without an inventive work.

FIG. 1 is a flowchart illustrating a method for accessing an application program according to various embodiments of the present disclosure;

FIG. 2 is a flowchart illustrating a method for accessing an application program according to various embodiments of the present disclosure;

FIG. 3 is a diagram illustrating an apparatus for accessing an application program according to various embodiments of the present disclosure;

FIG. 4 is a diagram illustrating an apparatus for accessing an application program according to various embodiments of the present disclosure; and

FIG. 5 is a diagram illustrating an apparatus for accessing an application program according to various embodiments of the present disclosure.

Corresponding reference numerals indicate corresponding parts throughout the several views of the drawings.

### DETAILED DESCRIPTION

Example embodiments will now be described more fully with reference to the accompanying drawings.

The present disclosure is described in further detail hereinafter with reference to accompanying drawings and examples to make the technical solution and merits therein clearer.

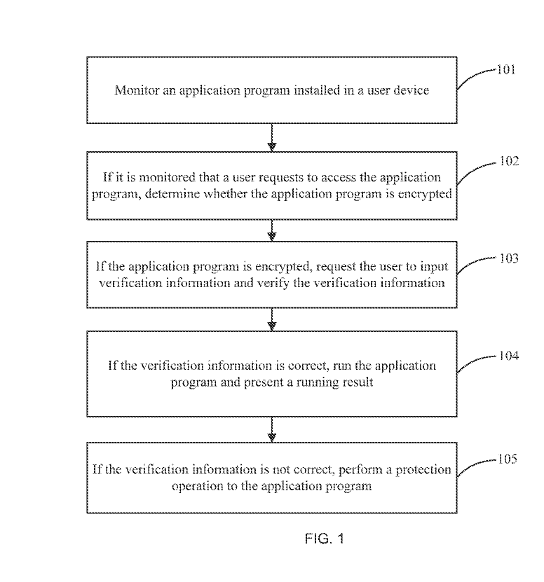

As shown in FIG. 1, this embodiment provides a method for accessing an application program, including the following.

At block 101, an application program installed in a user device is monitored.

At block 102, if it is monitored that a user requests to access the application program, it is determined whether the application program that the user requests to access is encrypted.

At block 103, if the application program that the user requests to access is encrypted, the user is requested to input verification information and it is determined whether the verification information is correct.

At block 104, if the verification information is correct, the application program that the user requests to access is run and a running result is presented.

At block 105, if the verification information is not correct, a protection operation is performed to the application program that the user requests to access.

When the user requests access to an application program, the verification information input by the user is verified. If the verification information is correct, the application program to which the user requests access is run and a running result is presented. If the verification information is not correct, a protection operation is applied to the application program to which the user requests access and it effectively prevents malicious access of other users to the application program. Thus, the security of the user information in the application program is ensured effectively.

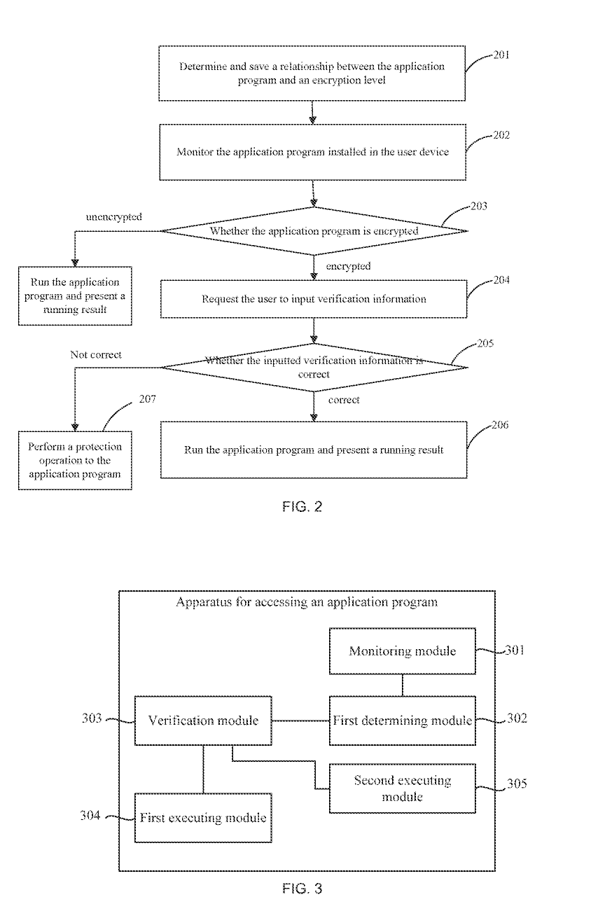

The embodiment of FIG. 2 provides a method for accessing an application program. The execution body of this method is a user device. Further, the method may be implemented by a client application program (e.g., a program lock) installed in the user device. The user device may be a cell phone, a palmtop computer, or a personal digital assistant (PDA). The method includes the following.

At block 201, a relationship between an application program and an encryption level is determined and saved, wherein the encryption level indicates whether the application program is encrypted. The encryption level may include: unencrypted, encrypted, hidden, or encrypted and hidden.

In various embodiments, the block may include receiving a program lock accessing request transmitted by the user. The program lock is used to manage application programs installed in the user device, e.g., manage configurations of encryption levels of the application programs. In various embodiments, the program lock may be displayed on the user device in form of a shortcut icon or a folder. The user may issue the program lock accessing request through clicking the shortcut icon or folder.

The program lock is run and an application program list and an encryption level configuration template are displayed. The encryption level configuration template provides encryption levels for the application programs. The user may select and configure encryption levels for the application programs through the displayed application program list and the encryption level configuration template.

An encryption configuration request transmitted by the user is received. The encryption configuration request includes an application program identifier and an encryption level. If the received encryption level is encrypt, the application program corresponding to the application program identifier is encrypted. The user is requested to input verification information of the application program identified by the application program identifier. The verification information input by the user is received, and a relationship between the application program identifier and the verification information is saved, so as to finish the encryption of the application program identified by the application program identifier. The verification information may include an encryption password and a user name, or include both of them.

In various embodiments of the present disclosure, application programs with an encryption level of encrypt may be encrypted using a uniform encryption password. Various embodiments of the present disclosure protect the application program and avoid malicious access to the application program through encrypting the application program.

If the received encryption level is hidden, the application program corresponding to the application program identifier is hidden. In various embodiments, a user interface (UI) of an application program identified by the application program identifier is hidden, wherein the UI may be a shortcut icon or folder. Through hiding the UI of the application program, the application program is hidden. Thus, malicious users cannot find the application program, which avoids malicious access to the application program and ensures the security of the user information in the application program to some extent.

If the received encryption level is encrypt and hidden, the application program identified by the application program identifier is encrypted and hidden. Detailed encryption and hiding operation may be seen from the above descriptions and is not repeated herein.

Various embodiments of the present disclosure implement an encryption and hiding dual protection of the application program through encrypting and hiding the application program, and increase the security level of the application program being accessed. The configuration of the encryption level of the application program may be implemented through the above manner. Thereafter, the relationship between the application program and the encryption level is saved locally.

At block 202, the application program installed in the user device is monitored.

At block 203, if it is monitored that the user requests to access the application program, it is determined whether the application program is encrypted. If the application program that the user requests to access is encrypted, block 204 is performed. If the application program that the user requests to access is not encrypted, the application program that the user requests to access is run and a running result is presented.

According to various embodiments, the user may request to access the application program through a UI of the application program displayed on the user device. If the UI of the application program is hidden, the user transmits an application program hidden cancellation request via the program lock. After the application program hidden cancellation request is received, the user is requested to input a password. The password is verified. If the password is correct, the hidden UI of the application program is displayed. Thus, the user may request to access the application program through the displayed UI of the application program.

Determining whether the application program that the user requests to access is encrypted may include querying the relationship between the application program and the encryption level according to the application program to which the user requests access to obtain the encryption level of the application program to which the user requests access and determining whether the application program is encrypted according to the encryption level of the application program. If the encryption level of the application program is unencrypted or hidden, it is determined that the application program is not encrypted. If the encryption level of the application program is encrypted or is encrypted and hidden, it is determined whether the application program is encrypted.

At block 204, the user is requested to input verification information. In various embodiments, when the user clicks the UI of the application program on the user device, a window used for inputting the verification information may pop-up on an interface of the user device, requesting the user to input the verification information. The pop-up window provides an information inputting interface. Thus, the user can input the verification information in the window that is popped out.

At block 205, it is determined whether the input verification information is correct. If the verification information is correct, block 206 is performed. If the verification information is not correct, block 207 is performed. In various embodiments, the user device stores the correct verification information in advance. After the user inputted verification information is received, the verification information input by the user is compared with the pre-stored verification information. If they are the same, the verification of the user input verification information succeeds. If they are different, it is determined that the user input verification information is not correct.

At block 206, the application program that the user requests to access is run and a running result is presented.

At block 207, a protection operation is performed to the application program that the user requests to access.

The user is prompted to input the verification information again and the method returns to the process of determining whether the input verification information is correct. If the user has input incorrect verification information for a predefined number of times, running of the application program is forbidden, or information is promptly output to inform the user that the application program cannot be accessed. The process of promptly outputting the information includes notifying the user that the application program has a fault via voice or a window. The application program in various embodiments may include a storage space for storing user private information. The user private information may include a short message, call record, mail, picture, or video.

When the user requests to access an application program, verification information input by the user is verified. If the verification information is correct, the application program to which the user requests to access is run and a running result is presented. If the verification information is not correct, a protection operation is performed to the application program to which the user requests to access. This prevents malicious accessing of other users to the application program and ensures the security of the user information in the application program effectively.

As shown in FIG. 3, an apparatus for accessing an application program is provided. The apparatus includes: a monitoring module 301, a first determining module 302, a verification module 303, a first executing module 304 and a second executing module 305.

The monitoring module 301 is adapted to monitor an application program installed in a user device. The first determining module 302 is adapted to determine, when it is monitored that a user requests access to the application program, whether the application program to which the user requests access is encrypted. The verification module 303 is adapted to request, if the application program to which the user requests access is encrypted, the user to input verification information and determine whether the verification information is correct. The first executing module 304 is adapted to run, if the verification information is correct, the application program to which the user requests access and present a running result.

The second executing module 305 is adapted to execute a protection operation to the application program to which the user requests access if the verification information is not correct.

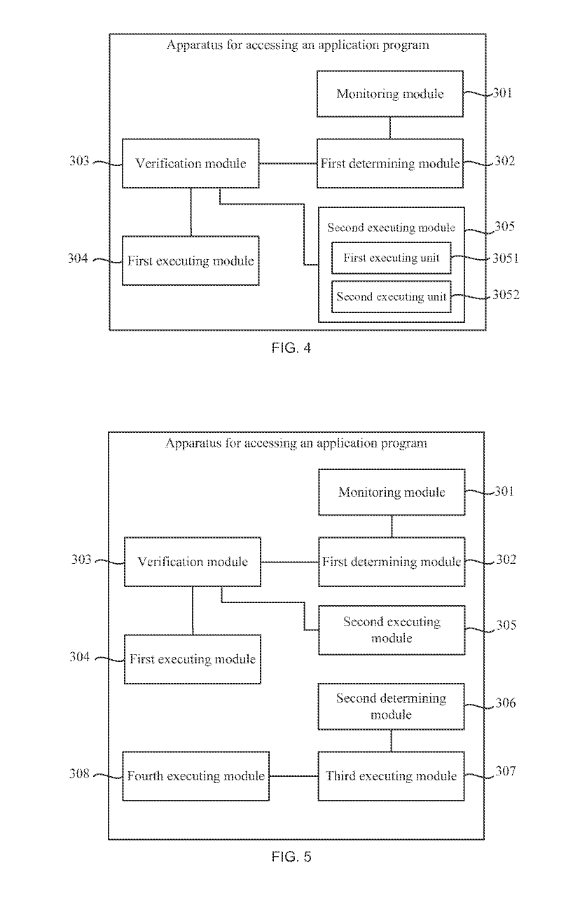

As shown in FIG. 4, the second executing module 305 in FIG. 3 may include a first executing unit 3051, adapted to prompt the user to input the verification information again and trigger the verification module 303 to determine whether the verification information is correct. The second executing module 305 may also include a second executing unit 3052, adapted to forbid the running of the application program if the user has input error verification information for a predefined number of times, or output prompt information prompting the user that the application program cannot be accessed. In various embodiments, the second executing unit 3052 is adapted to inform the user that the application program has a fault via voice or a window.

As shown in FIG. 5, the apparatus in FIG. 3 may further include the following:

a second determining module 306, adapted to determine a relationship between the application program and an encryption level, wherein the encryption level indicates whether the application program is encrypted, and the encryption level includes unencrypted, encrypted, hidden, or encrypted and hidden;

a third executing module 307, adapted to hide a UI of the application program if the encryption level of the application program is hidden or is encrypted and hidden; and

a fourth executing module 308, adapted to receive an application program hidden cancellation request transmitted by the user, request the user to input a password, verify the password, and display the hidden application program if the password is correct.

In various embodiments, the second determining module 306 is adapted to query a relationship between the application program that the user requests to access and the encryption level to obtain the encryption level of the application program, and determine whether the application program is encrypted according to the encryption level of the application program.

Various embodiments also provide a terminal which includes an apparatus for accessing an application program. The terminal includes, but is not limited to, a cell phone, a palmtop computer, or a personal digital assistant (PDA).

When the user requests to access an application program, the verification information input by the user is verified. If the verification information is correct, the application program to which the user requests access is run and a running result is presented. If the verification information is not correct, a protection operation is performed to the application program to which the user requests access. It effectively prevents malicious access of other users to the application program. Thus, the security of the user information in the application program is ensured effectively.

The apparatus for accessing an application program is described above by taking the division of above functional modules as an example. In a practical application, the functions may be implemented by different modules according to a requirement, i.e., the apparatus may be divided into different functional modules, so as to implement all or some functions described above. In addition, the apparatus for accessing an application program and the method for accessing an application program have the same idea. The detailed implementation of the apparatus may be seen from the method examples and is not repeated herein.

The serial numbers of the various embodiments of the present disclosure are merely used for the description but do not represent any preference of the embodiments.

Those with ordinary skill in the art would know that all or some of the processes of the present disclosure may be implemented by hardware, or implemented by a program executed on a relevant hardware. The program may be stored on a computer readable storage medium. The storage medium may be a read only memory, a disk, or a compact disk.

What has been described and illustrated herein is a preferred example of the disclosure along with some of its variations. Many variations are possible within the scope of the disclosure, which is intended to be defined by the following claims—and their equivalents—in which all terms are meant in their broadest reasonable sense unless otherwise indicated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for accessing an application program, comprising:
monitoring an application program installed in a user device;
if it is monitored that a user requests to access the application program, determining whether the application program is encrypted;
if the application program that the user requests to access is encrypted, requesting the user to input verification information, determining whether the verification information is correct;
if the verification information is correct, running the application program that the user requests to access and presenting a running result; and
if the verification is not correct, executing a protection operation to the application program that the user requests to access.

2. The method of claim 1, further comprising:
before monitoring the application program installed in the user device,
determining a relationship between the application program and an encryption level, wherein the encryption level is used for indicating whether the application program is encrypted, the encryption level comprises unencrypted, encrypted, hidden, or hidden and encrypted;
if the encryption level of the application program is hidden or is encrypted and hidden, hiding a user interface (UI) of the application program.

3. The method of claim 2, further comprising:
after hiding the UI of the application program,
receiving an application program hidden cancellation request transmitted by the user, requesting the user to input a password, and verifying the password;
if the password is correct, displaying the hidden UI of the application program again.

4. The method of claim 1, wherein the determining whether the application program that the user requests to access is encrypted comprises:
querying a relationship between the application program that the user requests to access and the encryption level to obtain the encryption level of the application program that the user requests to access, and determining whether the application program is encrypted according to the encryption level of the application program.

5. The method of claim 1, wherein the executing the protection operation to the application program if the verification is not correct comprises:
prompting the user to input the verification information again and returning to the process of determining whether the verification information is correct;
if the user has inputted error verification information for a predefined number of times, forbidding the running of the application program, or, outputting prompt information prompting the user that the application program cannot be accessed.

6. The method of claim 5, wherein the outputting the prompt information comprises:
informing the user that the application program has a fault via voice or a window.

7. An apparatus for accessing an application program, comprising:
one or more processors;
a memory; and
one or more program modules stored in the memory and to be executed by the one or more processors, the one or more program modules comprise: a monitoring module, a first determining module, a verification module, a first executing module and a second executing module; wherein
the monitoring module is adapted to monitor an application program installed in a user device;
the first determining module is adapted to determine, when it is monitored that a user requests to access the application program, whether the application program that the user requests to access is encrypted;
the verification module is adapted to request, if the application program that the user requests to access is encrypted, the user to input verification information and determine whether the verification information is correct;
the first executing module is adapted to run, if the verification information is correct, the application program that the user requests to access and present a running result; and
the second executing module is adapted to execute a protection operation to the application program that the user requests to access if the verification information is not correct.

8. The apparatus of claim 7, further comprising:
a second determining module, adapted to determine a relationship between the application program and an encryption level, wherein the encryption level indicates whether the application program is encrypted, and the encryption level comprises unencrypted, encrypted, hidden, or encrypted and hidden; and
a third executing module, adapted to hide a user interface (UI) of the application program if the encryption level of the application program is hidden or is encrypted and hidden.

9. The apparatus of claim 8, further comprising:
a fourth executing module, adapted to receive an application program hidden cancellation request transmitted by the user, request the user to input a password, verify the password, and display the hidden application program again if the password is correct.

10. The apparatus of claim 7, wherein the second determining module is adapted to query a relationship between the application program that the user requests to access and the encryption level to obtain the encryption level of the application program, and determine whether the application program is encrypted according to the encryption level of the application program.

11. The apparatus of claim 7, wherein the second executing module comprises:
a first executing unit, adapted to prompt the user to input the verification information again and trigger the verification module to determine whether the verification information is correct; and
a second executing unit, adapted to forbid the running of the application program if the user has inputted error verification information for a predefined number of times, or output prompt information prompting the user that the application program cannot be accessed.

12. The apparatus of claim 11, wherein the second executing unit is adapted to inform the user that the application program has a fault via voice or a window.

13. A non-transitory computer-readable storage medium comprising a set of instructions for accessing an application program, the set of instructions to direct at least one processor to perform acts of:
monitoring an application program installed in a user device;
if it is monitored that a user requests to access the application program, determining whether the application program is encrypted;
if the application program that the user requests to access is encrypted, requesting the user to input verification information, determining whether the verification information is correct;
if the verification information is correct, running the application program that the user requests to access and presenting a running result; and
if the verification is not correct, executing a protection operation to the application program that the user requests to access.
